(19) United States
(12) Patent Application Publication
(10) Pub. No.: US 2019/0375555 A1
(43) Pub. Date: Dec. 12, 2019

(54) Tethered Bridge Closure

(71) Applicant: Closure Systems International Inc., Memphis, TN (US)

(72) Inventors: John Edie, Linden, IN (US); Leland T. Lutton, Crawfordsville, IN (US)

(21) Appl. No.: 16/437,673

(22) Filed: Jun. 11, 2019

Related U.S. Application Data
(60) Provisional application No. 62/683,905, filed on Jun. 12, 2018.

(51) Int. Cl. B65D 41/34; B65D 1/02; B65D 55/16

(52) U.S. Cl. CPC B65D 41/3428; B65D 55/16; B65D 1/0246

(57) ABSTRACT

A one-piece closure includes first and second closure portions. The first closure portion includes a top wall portion and an annular skirt portion. The skirt portion includes an internal thread formation and a first frangible connection that partially detachably connects sections of the skirt portion. The second closure portion includes a tamper-evident band that is partially detachably connected to the skirt portion by a second frangible connection. When the first and second frangible connections are broken, a tethered bridge is exposed. The tethered bridge is attached to a portion of the first and second closure portions and extends from about 5 to about 60 degrees around the circumference of the closure. The frangible connections extend from about 300 to about 355 degrees around the circumference of the closure.

### FIELD OF THE INVENTION

The present invention relates generally to a polymeric closure for a package. More specifically, the present invention relates to a tethered bridge one-piece polymeric closure to assist in preventing or inhibiting the closure from being separated from the container.

### BACKGROUND OF THE INVENTION

Polymeric closures have been used in many applications over the years in conjunction with containers. One type of polymeric closure that has been used with containers is a tamper-evident polymeric closure. Tamper-evident closures are used to prevent or inhibit tampering by providing a visible indication to a user if the closure has been opened. This visual indication typically divides the closure into two separate components after the tamper-evident feature has been broken. The top portion of the closure is then removed from the container to gain access to the contents of the containers. One drawback of tamper-evident closures being separated into two individual components is that the top portion may not be recycled along with the remainder of the closure and container. This scenario raises potential environmental concerns with so many containers having tamper-evident features that can be separated into two individual components.

It would be desirable to provide a closure that has tamper-evident features that address these above-noted environmental concerns, while still performing all of the desirable properties of a closure.

### SUMMARY

According to one embodiment, a one-piece closure comprises a first closure portion and a second closure portion. The first closure portion includes a polymeric top wall portion and a polymeric annular skirt portion depending from the polymeric top wall portion. The annular skirt portion includes an internal thread formation for mating engagement with an external thread formation of a container. The polymeric annular skirt portion includes a first frangible connection that partially detachably connects to a first section and a second section of the polymeric annular skirt portion. The second closure portion includes a polymeric tamper-evident band. The tamper-evident band depends from and is partially detachably connected to the polymeric annular skirt portion by a second frangible connection. When the first and second frangible connections are broken, a tethered bridge is exposed. The tethered bridge is attached to a portion of the second closure portion and a portion of the first closure portion. The tethered bridge extends from about 5 to about 60 degrees around the circumference of the closure. Each of the first and second frangible connections extends from about 300 to about 355 degrees around the circumference of the closure. When the internal thread formation of the first closure portion is not in mating engagement with the external thread formation of the container, the first closure portion is adapted to be spaced from the second closure portion via the tethered bridge.

According to another embodiment, a one-piece closure includes a first closure portion and a second closure portion. The first closure portion includes a polymeric top wall portion and a polymeric annular skirt portion depending from the polymeric top wall portion. The annular skirt portion includes an internal thread formation for mating engagement with an external thread formation of a container. The polymeric annular skirt portion includes a first frangible connection that partially detachably connects to a first section and a second section of the polymeric annular skirt portion. The second closure portion includes a polymeric tamper-evident band. The tamper-evident band depends from and is partially detachably connected to the polymeric annular skirt portion by a second frangible connection. When the first and second frangible connections are broken, a tethered bridge is exposed. The tethered bridge is attached to a portion of the second closure portion and a portion of the first closure portion. The tethered bridge has a length greater than about 1.5 mm. When the internal thread formation of the first closure portion is not in mating engagement with the external thread formation of the container, the first closure portion is adapted to be spaced from the second closure portion via the tethered bridge.

According to one embodiment, a package includes a container and a one-piece closure. The container has a neck portion defining an opening. The container has an external thread formation on the neck portion. The one-piece closure is configured for fitment to the neck portion of the container for closing the opening. The one-piece closure includes a first closure portion and a second closure portion. The first closure portion includes a polymeric top wall portion and a polymeric annular skirt portion depending from the polymeric top wall portion. The annular skirt portion includes an internal thread formation for mating engagement with the external thread formation of the neck portion. The polymeric annular skirt portion includes a first frangible connection that partially detachably connects to a first section and a second section of the polymeric annular skirt portion. The second closure portion includes a polymeric tamper-evident band. The tamper-evident band depends from and is partially detachably connected to the polymeric annular skirt portion by a second frangible connection. When the first and second frangible connections are broken, a tethered bridge is exposed. The tethered bridge is attached to a portion of the second closure portion and a portion of the first closure portion. The tethered bridge extends from about 5 to about 60 degrees around the circumference of the closure. Each of the first and second frangible connections extends from about 300 to about 355 degrees around the circumference of the closure. When the internal thread formation of the first closure portion is not in mating engagement with the external thread formation of the container, the first closure portion is adapted to be spaced from the second closure portion via the tethered bridge.

According to another embodiment, a package comprises a container and a one-piece closure. The container has a neck portion defining an opening and an external thread formation on the neck portion. The one-piece closure is configured for fitment to the neck portion of the container for closing the opening. The one-piece closure includes the first closure portion and the second closure portion. The first closure portion includes a polymeric top wall portion and a polymeric annular skirt portion. The polymeric annular skirt portion depends from the polymeric top wall portion. The annular skirt portion includes an internal thread formation for mating engagement with the external thread formation of the neck portion. The polymeric annular skirt portion includes a first frangible connection that partially detachably connects to a first section and a second section of the polymeric annular skirt portion. The second closure portion includes a polymeric tamper-evident band. The tamper-evident band depends from and is partially detachably connected to the polymeric annular skirt portion by a second frangible connection. When the first and second frangible connections are broken, a tethered bridge is exposed. The tethered bridge is attached to a portion of the second closure portion and a portion of the first closure portion. The tethered bridge has a length greater than about 1.5 mm. When the internal thread formation of the first closure portion is not in mating engagement with the external thread formation of the container, the first closure portion is adapted to be spaced from the second closure portion via the tethered bridge.

According to one method, a one-piece closure is formed. A first closure portion and a second closure portion of the one-piece closure is molded. The first closure portion includes a polymeric top wall portion and a polymeric annular skirt portion depending from the polymeric top wall portion. The annular skirt portion includes an internal thread formation for mating engagement with an external thread formation of a container. The second closure portion includes a polymeric tamper-evident band. A lower portion of the annular skirt portion is slit along a first general line and along a second general line. The first general line forms a first frangible connection that partially detachable connects a first section and a second section. The second general line forms a second frangible connection that partially detachable connects the annular skirt portion and the tamper-evident band. When the first and second frangible connections are broken, a tethered bridge is exposed. The tethered bridge extends from about 5 to about 60 degrees around the circumference of the closure. Each of the first and second frangible connections extends from about 300 to about 355 degrees around the circumference of the closure. When the internal thread formation of the first closure portion is not in mating engagement with the external thread formation of the container, the first closure portion is adapted to be spaced from the second closure portion via the tethered bridge.

The above summary is not intended to represent each embodiment or every aspect of the present invention. Additional features and benefits of the present invention are apparent from the detailed description and figures set forth below.

### BRIEF DESCRIPTION OF THE DRAWINGS

Other advantages of the invention will become apparent upon reading the following detailed description and upon reference to the drawings in which:

FIG. 1A is a top perspective view of a closure in a closed position according to one embodiment.

FIG. 1B is a cross-sectional view taken generally along line 1B-1B in FIG. 1A.

FIG. 1C is a side view of the closure of FIG. 1A.

FIG. 2A is a top perspective view of the closure of FIG. 1A in an open position.

FIG. 2B is an enlarged view of generally circular area 2B in FIG. 2A.

FIG. 3A is a top perspective view of a package including the closure of FIG. 1A and a container in a closed position according to one embodiment.

FIG. 3B is a cross-sectional view taken generally along line 3B-3B in FIG. 3A.

FIG. 3C is a side view of the closure of FIG. 3A.

FIG. 4 is a top perspective view of the closure and container of FIG. 3A in the open position.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

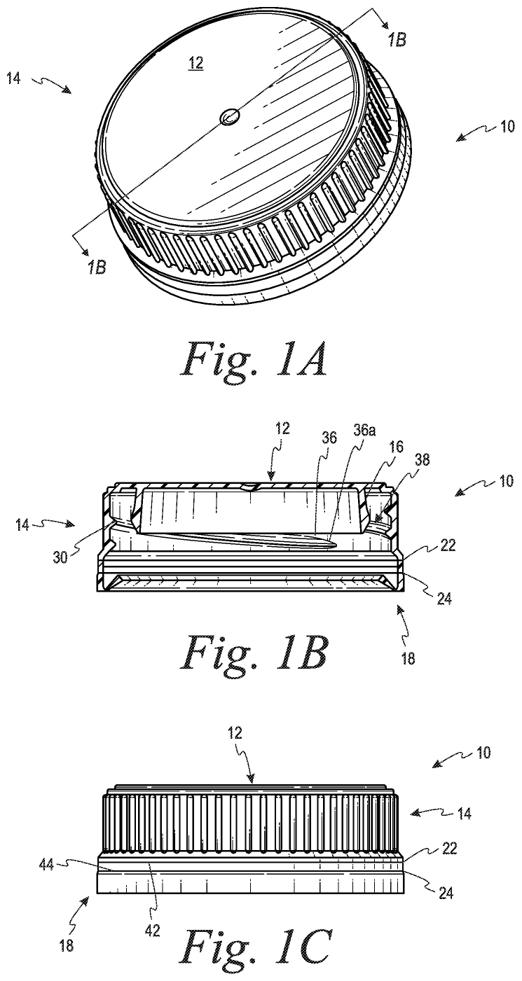

FIGS. 1A-C and 2A-B illustrate a polymeric closure 10 according to one embodiment of the present invention. The closures are configured to be placed on a container or bottle that contain product. The product is typically a liquid product, but also may be a solid product or a combination of a liquid and solid product. The polymeric closure 10 of FIGS. 1A-C and 2A-B is a one-piece closure assembly. The polymeric closure 10 is generally cylindrically shaped.

Referring still to FIGS. 1A-C and 2A-B, the polymeric closure 10 includes a polymeric top wall portion 12, a polymeric annular skirt portion 14 that depends from the polymeric top wall portion 12, a polymeric continuous plug seal 16 (FIG. 1B), and a tamper-evident band 18 (FIG. 1B). The top wall portion 12 extends across the entire top of the closure without any openings.

The polymeric annular skirt portion 14 includes a first frangible connection 22 that partially detachably connects to a first section and a second section of the polymeric annular skirt portion 14. The polymeric annular skirt portion 14 of FIG. 1B also includes an internal thread formation 30. The internal thread formation includes a plurality of leads in one embodiment. The internal thread formation 30 is configured for mating engagement with a corresponding external thread formation of a neck portion of a container. The internal thread formation 30 depicted in FIG. 1B includes a first closure lead 36 and a second closure lead 38. It is contemplated that the internal thread formation may be continuous in another embodiment.

The first closure lead 36 begins near the polymeric top wall portion 12 at a first position (not shown in FIG. 1B) and extends in a helical fashion to a second position 36a closer to the tamper-evident band 18. Similarly, the second closure lead 38 begins near the polymeric top wall portion 12 at a first position (not shown in FIG. 1B) and extends in a helical fashion to a second position (not shown in FIG. 1B) closer to the tamper-evident band 18. The first and second closure leads 36, 38 are referred collectively as a double lead closure thread. Each of the first and second closure leads 36, 38 is continuous. The first positions of the first and second closure leads 36, 38 are located roughly 180 degrees apart from each other and, thus, begin on generally opposing sides of the closure 10.

It is contemplated that the first and second closure leads may be discontinuous. It is also contemplated that the internal thread formation of the closure may differ from a helical thread formation. It is also contemplated that other internal thread formations may be used in the closure.

The polymeric continuous plug seal 16 of FIG. 1B depends from the polymeric top wall portion 12. The continuous plug seal 16 is spaced from an interior surface of the polymeric annular skirt portion 14.

In another embodiment, the closure may be sealed using a continuous liner located generally adjacent to a top wall portion. It is contemplated that other sealing methods may be used in sealing the closure.

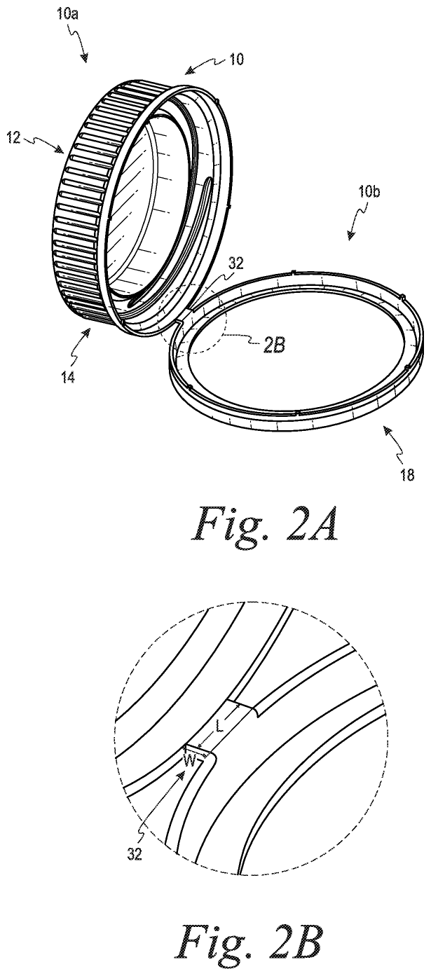

Referring specifically to FIG. 1B, the polymeric tamper-evident band 18 of the closure 10 is located at the bottom thereof (i.e., an end opposite of the polymeric top wall portion 12). The tamper-evident band 18 depends from and is partially detachably connected to the annular skirt portion 14 by the second frangible connection 24. The tamper-evident band 18 works in conjunction with the container to indicate to a user that the contents of the container may have been accessed. More specifically, the tamper-evident band 18 is designed to partially separate from the annular skirt portion 14 if a user opens the package and gains access to the container as shown, for example, in FIGS. 2A and 2B.

The first and second frangible connections 22, 24 may be formed by molded-in-bridges in one embodiment. The molded-in-bridges are typically formed using a feature in the mold. In another embodiment, the polymeric tamper-evident band may be formed using scoring or scored lines, notches, leaders, nicks or other lines of weaknesses.

Each of the first and second frangible connections 22, 24 generally extends from about 300 to about 355 degrees around the circumference of the closure. More specifically, each of the first and second frangible connections 22, 24 extends from about 320 to about 355 degrees around the circumference of the closure. In another embodiment, each of the first and second frangible connections 22, 24 extends from about 330 to about 355 degrees around the circumference of the closure. In a further embodiment, each of the first and second frangible connections 22, 24 extends from about 325 to 345 degrees.

When the first and second frangible connection 22, 24 are broken, a tethered bridge 32 is exposed as shown, for example, in FIGS. 2A, 2B. The tethered bridge 32 is attached to a portion of the second closure portion 10b (including the tamper-evident band 18) and a portion of the first closure portion or main body 10a (including the annular skirt portion 14 and the polymeric top wall portion 12). The tethered bridge 32 assists in maintaining the closure 10 as a one-piece assembly after the first and second frangible connections 22, 24 have been broken.

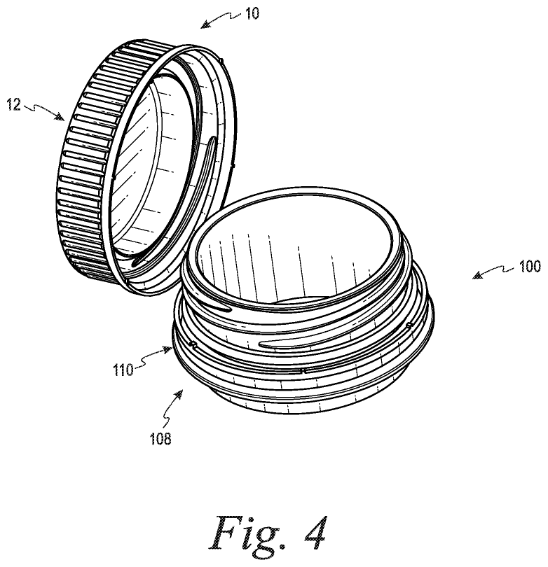

When the internal thread formation of the first closure portion is not in mating engagement with the external thread formation of the container, the first closure portion 10a is adapted to be spaced from the second closure portion 10b via the tethered bridge 32. One non-limiting example of the same is shown in FIGS. 2A, 2B with only the closure 10, while FIG. 4 depicts the same with a portion of the container 108. To assist in eliminating or reducing the chances of the first closure portion 10a from interfering with a user while, for example, drinking the contents of a container 108, the tethered bridge 32 extends from about 5 to about 60 degrees around the circumference of the closure in one embodiment. In other embodiments, the tethered bridge 32 generally extends from about 5 to about 40 degrees around the circumference of the closure. In a further embodiment, the tethered bridge 32 extends from about 5 to about 30 degrees around the circumference of the closure. In yet another embodiment, the tethered bridge extends from 15 to about 25 degrees around the circumference of the closure.

The tethered bridge 32 has a width W shown in FIG. 2B that provides the spacing between the first closure portion 10a from the second closure portion 10b. The width W is generally perpendicular to the outer periphery of the closure. In one embodiment, the width W of the tethered bridge is generally at least about 1 mm, desirably at least about 2 mm or even more desirably at least about 3 mm. The width W of the tethered bridge 32 is generally from about 1.5 to about 4 mm and more specifically from about 2 to about 4 mm.

The tethered bridge 32 also has a length L as shown best in FIG. 2B. The length L is generally tangential to the outer periphery of the closure. In one embodiment, the length L of the tethered bridge is generally at least about 1.5 mm, desirably at least about 3 mm or even more desirably at least about 6 mm. The length L of the tethered bridge 32 is generally from about 1.5 to about 6 mm and more specifically from about 2 to about 5 mm.

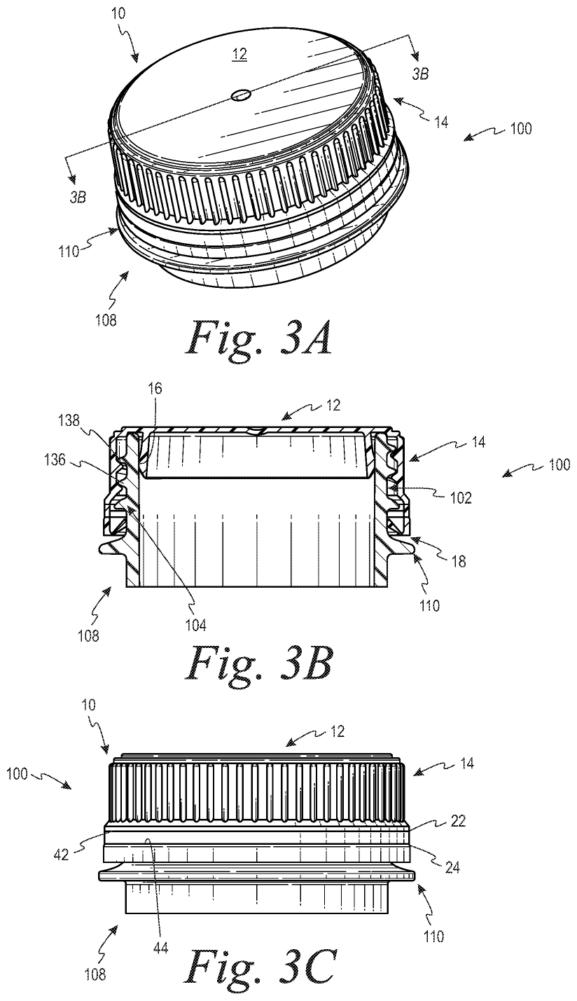

One non-limiting example of a closure and a container forming a package is shown and discussed in conjunction with FIGS. 3A-3C.

The closures of the present invention may be used with a container 108 used to form a package 100 of FIGS. 3A-3C. A portion of the container 108 is shown in FIGS. 3A-3C and includes a neck portion 102 that defines an opening. The neck portion 102 of the container 108 includes an external thread formation 104 and a continuous outer ring 110. The external thread formation 104 includes a first finish lead 136 and a second finish lead 138 (FIG. 3B). The external thread formation 104 (finish leads 136, 138) engages with the corresponding internal thread formation 30 (closure leads 36, 38) to seal the package 100.

The first finish lead 136 begins near the open end of the container 108 and extends in a helical fashion to a second position that is closer to the closed end of the container. Similarly, the second finish lead 138 starts closer to the open end of the container 108 and extends in a helical fashion to a second position that is closer to the closed end of the container. Each of the first and second finish leads 136, 138 is continuous. The first positions of the first and second finish leads 136, 138 are located roughly 180 degrees apart from each other and, thus, begin on opposing sides of the neck 102 of the container 108. When opening the container 108, the first closure lead 36 is desirably in contact with the first finish lead 136 and the second closure lead 38 is desirably in contact with the second finish lead 138. It is contemplated that the external thread formation of the container may have discontinuous leads.

It is contemplated that the external thread formation of the container may be different than that disclosed with respect to container 108.

The continuous outer ring 110 assists in positioning the tamper-evident band 18 when the first closure portion 10a is unthreaded from the neck 102 of the container 108 by the breaking of the first and second frangible connections 22, 24.

The closures of the present invention may include an oxygen-scavenger material. This oxygen-scavenger material may be distributed within the closure or may be a separate layer. The oxygen-scavenger material may be any material that assists in removing oxygen within the container, while having little or no effect on the contents within the container.

Alternatively, or in addition to, the closures may include an oxygen-barrier material. The oxygen-barrier material may be added as a separate layer or may be integrated within the closure itself. The oxygen-barrier materials assist in preventing or inhibiting oxygen from entering the container through the closure. These materials may include, but are not limited to, ethylene vinyl alcohol (EVOH). It is contemplated that other oxygen-barrier materials may be used in the closure.

The top wall portion 12 and the annular skirt portion 14, the continuous plug seal 16 and the tethered bridge 32 are made of polymeric material. The top wall portion 12, the annular skirt portion 14, the continuous plug seal 16 and the tethered bridge 32 are typically made of an olefin (e.g., polyethylene (PE), polypropylene (PP)), PET or blends thereof. One example of a polyethylene that may be used is high density polyethylene (HDPE). It is contemplated that the top wall portion, the annular skirt portion, the continuous plug seal and the tethered bridge may be made of other polymeric materials. The tamper-evident band 18 is typically made of the same materials as the top wall portion 12, the annular skirt portion 14, the continuous plug seal 16 and the tethered bridge 32.

The closures are typically formed by processes such as injection or compression molding, extrusion or the combination thereof.

In one process, the tethered bridge is formed by double slitting using two blades. The double-slitting is formed in one process along general lines 42 and 44 of FIG. 1C and uses scoring or scored lines, notches, leaders, nicks or line of weaknesses to provide separation of the connection along both general lines 42 and 44 via respective first and second frangible connections 22, 24. The general lines 42 and 44 are located on opposite sides of the tether to be formed. The slitting may form this frangible connection or the frangible connection may be formed at a later time. The double slitting in this process does not extend entirely around the circumference of the closure 10. Specifically, the general line 42 extends generally around the circumference of the closure 10 except in the area that eventually forms the tethered bridge 32, while general line 44 extends around the circumference of the closure 10 except in the area that eventually forms attached the tethered bridge 32. It is contemplated that the lines may be different than those depicted in FIG. 1C.

In other process, the tethered bridge may be formed by using molds in the absence of slitting. In one process, general lines 42 and 44 are formed by using bridges (e.g., molded-in-bridges) to provide separation of the connection along both general lines 42 and 44 via respective first and second frangible connections 22, 24. The molded-in-bridges do not extend entirely around the circumference of the closure 10. Specifically, the general line 42 extends generally around the circumference of the closure 10 except in the area that eventually forms the tethered bridge 32, while general line 44 extends around the circumference of the closure 10 except in the area that eventually forms the tethered bridge 32.

The container 108 is typically made of polymeric material. One non-limiting example of a material to be used in forming a polymeric container is polyethylene terephthalate (PET), polypropylene (PP) or blends using the same. It is contemplated that the container may be formed of other polymeric or copolymer materials. It is also contemplated that the container may be formed of glass. The container 108 typically has an encapsulated oxygen-barrier layer or oxygen barrier material incorporated therein.

To open the container 108 and gain access to the product therein, the closure 10 is unthreaded by turning the closure 10 with respect to the container 108. After the closure has been unthreaded, the closure 10 is spaced apart as shown in FIG. 4.

The polymeric closures are desirable in both low-temperature and high-temperature applications. The polymeric closures may be used in low-temperature applications such as an ambient or a cold fill. These applications include water, sports drinks, aseptic applications such as dairy products, and pressurized products such as carbonated soft drinks. It is contemplated that other low-temperature applications may be used with the polymeric closures formed by the processes of the present invention.

The polymeric closures may be exposed to high-temperature applications such as hot-fill, pasteurization, and retort applications. A hot fill application is generally performed at temperatures around 185° F., while a hot-fill with pasteurization is generally performed at temperatures around 205° F. Retort applications are typically done at temperatures greater than 250° F. It is contemplated that the polymeric closures can be used in other high-temperature applications.

1. A one-piece closure comprising:
a first closure portion including:
a polymeric top wall portion; and
a polymeric annular skirt portion depending from the polymeric top wall portion, the annular skirt portion including an internal thread formation for mating engagement with an external thread formation of a container, the polymeric annular skirt portion including a first frangible connection that partially detachably connects to a first section and a second section of the polymeric annular skirt portion; and
a second closure portion including:
a polymeric tamper-evident band, the tamper-evident band depending from and being partially detachably connected to the polymeric annular skirt portion by a second frangible connection,
wherein when the first and second frangible connections are broken, a tethered bridge is exposed, the tethered bridge being attached to a portion of the second closure portion and a portion of the first closure portion, the tethered bridge extending from about 5 to about 60 degrees around the circumference of the closure,
wherein each of the first and second frangible connections extends from about 300 to about 355 degrees around the circumference of the closure,
wherein when the internal thread formation of the first closure portion is not in mating engagement with the external thread formation of the container, the first closure portion being adapted to be spaced from the second closure portion via the tethered bridge.

2. The closure of claim 1, wherein the tethered bridge extends from about 5 to about 40 degrees around the circumference of the closure and wherein each of the first and second frangible connections extends from about 320 to about 355 degrees around the circumference of the closure.

3. The closure of claim 2, wherein the tethered bridge extends from about 15 to about 35 degrees around the circumference of the closure and wherein each of the first and second frangible connections extends from about 325 to about 345 degrees around the circumference of the closure.

4. The closure of claim 1, wherein the shape of the closure is generally cylindrical.

5. The closure of claim 1, wherein the closure further includes an oxygen-scavenger material or an oxygen-barrier material.

6. The closure of claim 1, wherein the internal thread formation of the annular skirt portions includes at least one helical thread element.

7. The closure of claim 1, wherein the closure comprises polyolefins.

8. The closure of claim 1, wherein the first closure portion further includes a polymeric continuous plug seal depending from the polymeric top wall portion, the continuous plug seal being spaced from an interior surface of the polymeric annular skirt portion.

9. A one-piece closure comprising:
a first closure portion including:
a polymeric top wall portion; and
a polymeric annular skirt portion depending from the polymeric top wall portion, the annular skirt portion including an internal thread formation for mating engagement with an external thread formation of a container, the polymeric annular skirt portion including a first frangible connection that partially detachably connects to a first section and a second section of the polymeric annular skirt portion; and
a second closure portion including:
a polymeric tamper-evident band, the tamper-evident band depending from and being partially detachably connected to the polymeric annular skirt portion by a second frangible connection,
wherein when the first and second frangible connections are broken, a tethered bridge is exposed, the tethered bridge being attached to a portion of the second closure portion and a portion of the first closure portion, the tethered bridge having a length greater than about 1.5 mm,
wherein when the internal thread formation of the first closure portion is not in mating engagement with the external thread formation of the container, the first closure portion being adapted to be spaced from the second closure portion via the tethered bridge.

10. The closure of claim 9, wherein the length of the tethered bridge is greater than 3 mm.

11. The closure of claim 10, wherein the length of the tethered bridge is greater than 6 mm.

12. The closure of claim 9, wherein the length of the tethered bridge is from about 2 to about 5 mm.

13. The closure of claim 9, wherein the closure comprises polyolefins.

14. The closure of claim 9, wherein the first closure portion further includes a polymeric continuous plug seal depending from the polymeric top wall portion, the continuous plug seal being spaced from an interior surface of the polymeric annular skirt portion.

15. A package comprising:
a container having a neck portion defining an opening, the container having an external thread formation on the neck portion; and
a one-piece closure being configured for fitment to the neck portion of the container for closing the opening, the one-piece closure including a first closure portion and a second closure portion,
the first closure portion including:
a polymeric top wall portion; and
a polymeric annular skirt portion depending from the polymeric top wall portion, the annular skirt portion including an internal thread formation for mating engagement with the external thread formation of the neck portion, the polymeric annular skirt portion including a first frangible connection that partially detachably connects to a first section and a second section of the polymeric annular skirt portion; and
the second closure portion including:
a polymeric tamper-evident band, the tamper-evident band depending from and being partially detachably connected to the polymeric annular skirt portion by a second frangible connection,
wherein when the first and second frangible connections are broken, a tethered bridge is exposed, the tethered bridge being attached to a portion of the second closure portion and a portion of the first closure portion, the tethered bridge extending from about 5 to about 60 degrees around the circumference of the closure,
wherein each of the first and second frangible connections extends from about 300 to about 355 degrees around the circumference of the closure,
wherein when the internal thread formation of the first closure portion is not in mating engagement with the external thread formation of the container, the first closure portion being adapted to be spaced from the second closure portion via the tethered bridge.

16. The package of claim 15, wherein the tethered bridge extends from about 5 to about 30 degrees around the circumference of the closure and wherein each of the first and second frangible connections extends from about 330 to about 355 degrees around the circumference of the closure.

17. A package comprising:
a container having a neck portion defining an opening, the container having an external thread formation on the neck portion; and
a one-piece closure being configured for fitment to the neck portion of the container for closing the opening, the one-piece closure including the first closure portion and the second closure portion,
the first closure portion including:
a polymeric top wall portion; and
a polymeric annular skirt portion depending from the polymeric top wall portion, the annular skirt portion including an internal thread formation for mating engagement with the external thread formation of the neck portion, the polymeric annular skirt portion including a first frangible connection that partially detachably connects to a first section and a second section of the polymeric annular skirt portion; and
the second closure portion including:
a polymeric tamper-evident band, the tamper-evident band depending from and being partially detachably connected to the polymeric annular skirt portion by a second frangible connection,
wherein when the first and second frangible connections are broken, a tethered bridge is exposed, the tethered bridge being attached to a portion of the second closure portion and a portion of the first closure portion, the tethered bridge having a length greater than about 1.5 mm,
wherein when the internal thread formation of the first closure portion is not in mating engagement with the external thread formation of the container, the first closure portion being adapted to be spaced from the second closure portion via the tethered bridge.

18. The package of claim 17, wherein the length of the tethered bridge is from about 2 to about 5 mm.

19. A method of forming a one-piece closure, the method comprising:
molding a first closure portion and a second closure portion of the one-piece closure, the first closure portion including a polymeric top wall portion and a polymeric annular skirt portion depending from the polymeric top wall portion, the annular skirt portion including an internal thread formation for mating engagement with an external thread formation of a container, the second closure portion including a polymeric tamper-evident band; and
slitting a lower portion of the annular skirt portion along a first general line and along a second general line, the first general line forming a first frangible connection that partially detachable connects a first section and a second section, the second general line forming a second frangible connection that partially detachable connects the annular skirt portion and the tamper-evident band,
wherein when the first and second frangible connections are broken, a tethered bridge is exposed, the tethered bridge extending from about 5 to about 60 degrees around the circumference of the closure, each of the first and second frangible connections extending from about 300 to about 355 degrees around the circumference of the closure,
wherein when the internal thread formation of the first closure portion is not in mating engagement with the external thread formation of the container, the first closure portion being adapted to be spaced from the second closure portion via the tethered bridge.

20. The method of claim 19, wherein the tethered bridge extends from about 15 to about 35 degrees around the circumference of the closure and wherein each of the first and second frangible connections extends from about 325 to about 345 degrees around the circumference of the closure.
